(19) United States
(12) Patent Application Publication
(10) Pub. No.: US 2009/0223262 A1
(43) Pub. Date: Sep. 10, 2009

(54) Anti-theft device for machine-operated implements

(76) Inventor: Richard Zymroz, Moon Township, PA (US)

Correspondence Address: BUCHANAN, INGERSOLL & ROONEY PC, POST OFFICE BOX 1404, ALEXANDRIA, VA, 22313-1404, US

(21) Appl. No.: 12/073,540

(22) Filed: Mar. 6, 2008

(51) Int. Cl. G05G 5/00

(52) U.S. Cl. 70/174

(57) ABSTRACT

An anti-theft device for a machine-operated implements includes an adjustable shaft and a locking mechanism. The adjustable shaft includes at least a first adjustable member having a first end portion and a second adjustable member having a substantially perpendicular bar portion located a sufficient distance from an exposed end of the second adjustable member. The anti-theft device is placed on a machine-operated implement to prevent attachment of an earth mover thereto and subsequent theft.

### SUMMARY

Provided is an anti-theft device for a machine-operated implement. The anti-theft device comprises an adjustable shaft and a locking mechanism. In the preferred embodiment, the adjustable shaft is telescoping and includes a first adjustable member and a second adjustable member, which is at least partially received within the first adjustable member. The first adjustable member and the second adjustable member each include at least one hole for receiving the locking mechanism and have a length of about 10 inches to about 20 inches. The first adjustable member includes a lateral arm in the form of an angle iron. The second adjustable member includes a lateral arm in the form of a C-shaped channel member located at a distance from the end of the second adjustable member. The anti-theft device is designed to be attached to a machine-operated implement, such as an earth mover attachment, to prevent attachment of an earth mover to the machine-operated implement.

In the preferred embodiment, the locking mechanism includes a locking pin and a lock. The lock may be a key lock or a key tumbler lock.

The anti-theft device is formed of a material selected from the group consisting of metal, wood, plastic, and combinations thereof. The metal can be a case hardened metal. In the preferred embodiment, the first adjustable member includes a hollow body adapted to at least partially receive the second adjustable member therein. The hollow body may have a round, square, rectangular, or polygonal cross-section designed to receive the second adjustable member therein. A hollow body having a square, rectangular, or polygonal cross-section preferably has inner dimensions of about 0.05 inches to about 2.0 inches. A hollow body having a round cross-section has an inner diameter of about 0.05 inches to about 2.0 inches.

The second adjustable member includes a substantially perpendicular bar portion (lateral arm), which may be a C-shaped channel member. In the preferred embodiment, the substantially perpendicular bar portion is located about 0.5 inches to about 5 inches from the exposed end of the second adjustable member. The C-shaped channel member is located a sufficient distance from the exposed end to prevent downward movement of the exposed end.

### BRIEF DESCRIPTION OF THE FIGURES

FIG. 1 is a front view of an assembled anti-theft device for a machine-operated implement.

FIGS. 2A and 2B are front views of the telescoping members of the anti-theft device for a machine-operated implement, with partial cross-sectional details.

FIG. 3 is a side view of the assembled anti-theft device of FIG. 1.

FIGS. 4A and 4B are side views of the telescoping members of the anti-theft device of FIG. 1.

FIG. 5 is a reduced scale front view of the anti-theft device of FIG. 1 as installed on a machine-operated implement in locking position.

FIG. 6 is a partial cross-sectional view taken along the line 6-6 of FIG. 5.

### DETAILED DESCRIPTION

Provided is an anti-theft device for an earth mover attachment or a machine-operated implement, such as, without limitation, angle brooms, augers, backhoes, bale forks, landscape rakes, mowers, pallet forks, planers, grapple forks and buckets, landplanes, tree spades, trenchers, trench compactors, vibratory plows, boring units, box blades, breakers, rotary cutters, scarifiers, scrapers, seeders, brush saws, chippers, snow blades, snow blowers, snow pushers concrete mixers, concrete pumps, diggers, dozer blades, sod layers, soil conditioners, spreaders, drop hammers, dumping hoppers, flail cutters, graders, stump grinders, sweepers, tillers, wheel saws, or vibratory rollers. The earth mover attachments or machine-operated implements generally include an interface for a universal quick coupler system, such as a hydraulic quick coupler system found on Caterpillar® machines, which attaches the earth mover attachment to the loader attachment of the earth mover.

The anti-theft device disclosed herein is designed to be attached to the machine-operated implement via the universal quick coupler system to prevent an earth mover from gripping and moving the machine-operated implement. Given the size and weight of the machine-operated implement, locking the quick coupler system effectively prevents theft of the associated attachment.

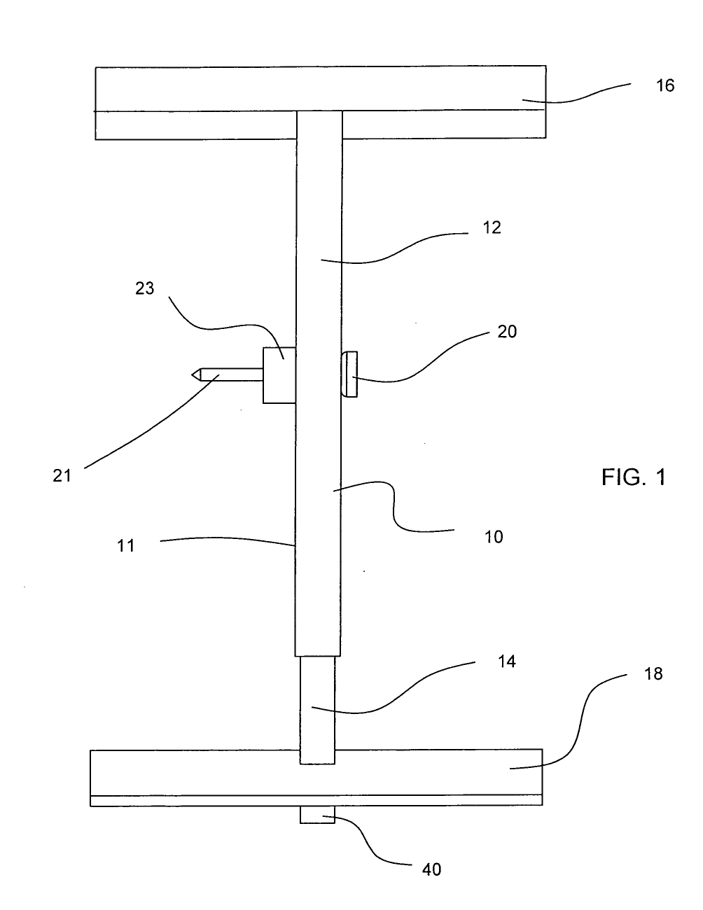

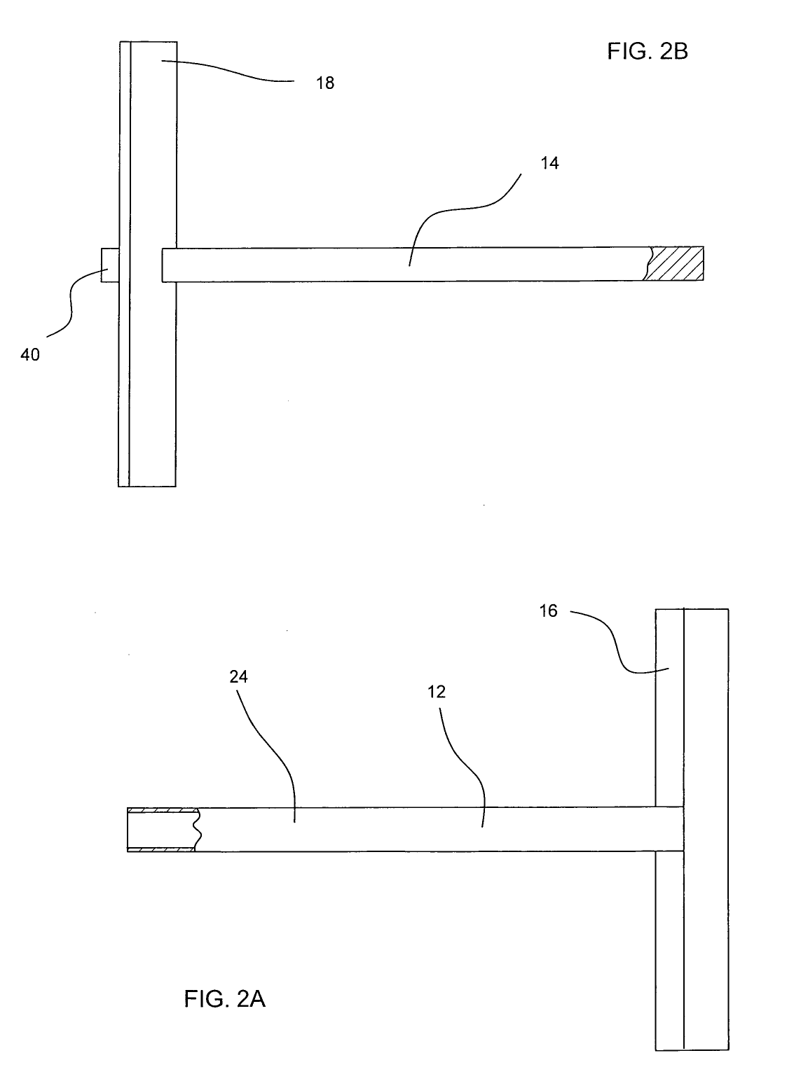

As shown in FIG. 1 and FIGS. 2A and 2B, the anti-theft device 10 includes an adjustable shaft 11. Preferably, the adjustable shaft 11 is telescoping. In the preferred embodiment, the adjustable shaft 11 includes a first adjustable member 12 and a second adjustable member 14. The first adjustable member 12 and the second adjustable member 14 may be telescoping members, such that the second adjustable member 14 slides at least partially into and out of the first adjustable member 12 to form the adjustable shaft 11. The first adjustable member 12 includes a first end portion 16 (lateral arm) and the second adjustable member 14 includes a substantially perpendicular bar portion 18 (lateral arm) located about 0.5 inches to about 5 inches from the exposed end 40 of the second adjustable member 14 (e.g., about 1.0 inch to about 4 inches, about 1.5 inches to about 3.5 inches, or about 2.0 inches to about 3.0 inches). The substantially perpendicular bar portion 18 prevents downward movement of the exposed end 40 once the anti-theft device is installed on a machine-operated implement. Once the first and second adjustable members 12, 14 are set at the desired length, a locking mechanism 20 is used to lock the first and second adjustable members 12, 14 in place. In other embodiments, the adjustable shaft 11 may include three or more adjustable members (e.g., three or more telescoping members). Since the first and second adjustable members 12, 14 are adjustable and/or telescoping; the length of the anti-theft device can be adjusted to fit the coupler system of the machine-operated implement and can be adjusted for easy removal of the anti-theft device from the coupler system.

In the preferred embodiment, the anti-theft device is formed of a metal. Preferably, the metal is case hardened so that the anti-theft device is not easily cut, broken and/or bent. In alternative embodiments, the anti-theft device may be formed of wood or plastic. Preferably, the plastic is a high density plastic, which is not easily broken, bent, and/or cut.

In the preferred embodiment, the first adjustable member 12 includes a hollow body 24 that is sized to received the second adjustable member 14. The hollow body 24 may be about 10 inches to about 20 inches in length, more preferably about 12 inches to about 16 inches. In the preferred embodiment, the hollow body 24 is about 13 inches to about 14 inches in length. The hollow body 24 can have a square, round, or polygonal cross-section. When the hollow body 24 has a round cross-section, the inner diameter of the hollow body 24 is about 0.50 inches to about 2.0 inches and preferably less than about 1.0 inch, but larger than the outer diameter of the second adjustable member 14. In the preferred embodiment, the outer diameter of the hollow body 24 is about 1.0 inch. When the hollow body 24 has a square cross-section, the inner dimensions of the hollow body are about 0.05 inches to about 2.0 inches in width and height. Preferably, when the hollow body has a square cross-section, the inner dimensions of the hollow body 24 are less than about 1.0 inch by 1.0 inch, but larger than the outer dimensions of the second adjustable member 14. The walls of the hollow body 24 are about 0.05 inches to about 1.0 inch thick. Preferably, the thickness of the walls of the hollow body 24 is uniform along the length thereof. In other embodiments, the thickness of the walls of the hollow body 24 can vary along the length of the hollow body. Preferably, the walls of the hollow body 24 are sufficiently thick to prevent bending of the first adjustable member 12.

In the preferred embodiment, the second adjustable member 14 may be solid. In an alternate embodiment, the second adjustable member 14 may be hollow. The second adjustable member 14 may have a round, square, or polygonal cross-section. The cross-section of the second adjustable member 14 can be the same or different as the hollow body 24 of the first adjustable member 12. Preferably, the second adjustable member 14 and the hollow body 24 of the first adjustable member 12 have the same cross-section. In an embodiment, the second adjustable member 14 has a different cross-sectional shape than the inner diameter of the first adjustable member 12, and the second adjustable member 14 is sized and configured to be received within the first adjustable member 12. When the second adjustable member 14 has a round cross-section, the outer diameter of the second adjustable member 14 is about 0.5 inches to about 2.0 inches and preferably about 0.5 inches to about 1.0 inches. In the preferred embodiment, the outer diameter of the second adjustable member 14 is about 0.75 inches. When the second adjustable member 14 has a square cross-section, the outer dimensions of the second adjustable member 14 are about 0.5 inches to about 2.0 inches in width, and height. Preferably, the outer dimensions of the second adjustable member 14 having a square cross-section are about 0.75 inches by 0.75 inches, and are smaller than the inner dimensions of the first adjustable member 12.

In the preferred embodiment, the outer diameter or dimensions of the second adjustable member 14 is slightly smaller, about 0.010 to 0.5 inches smaller, than the inner diameter or dimensions of the hollow body 24 of the first adjustable member 12 so that the second adjustable member 14 can freely slide at least partially into and out of the hollow body 24 (e.g., about 0.1 inches to about 0.4 inches, or about 0.2 inches to about 0.3 inches). In the preferred embodiment, the outer diameter or dimensions of the second adjustable member 14 are about 0.25 inches smaller than the inner diameter or dimensions of the hollow body 24 of the first adjustable member 12.

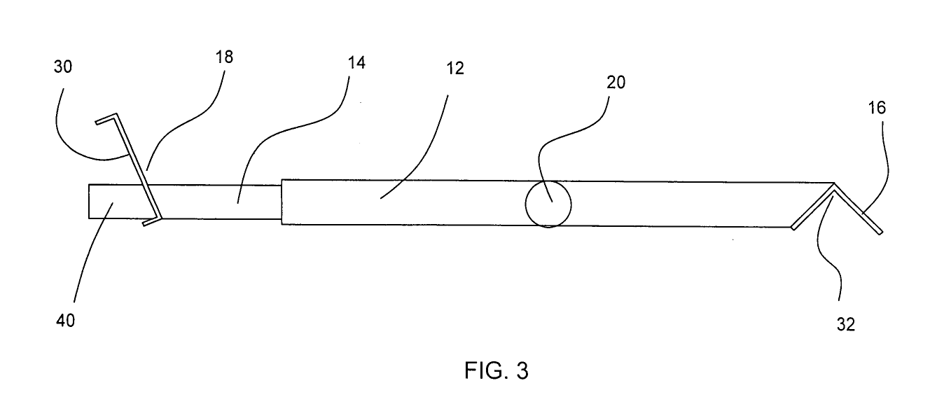

FIG. 3 is a side view of the anti-theft device 10. As shown, the first end portion 16 includes a wedge-shaped portion 32, such as an angle iron, which fits within an upper edge of the universal coupler system of earth mover attachments. The first adjustable member 12 is connected to the first end portion 16 at a central location along the first end portion 16. However, in alternative embodiment, the first adjustable member 12 may be attached at other locations along the first end portion 16. The substantially perpendicular bar portion 18 includes a C-shaped channel portion 30 that fits within a lower edge of the universal coupler system of earth mover attachments. The second adjustable member 14 is connected to the substantially perpendicular bar portion 18 at a central location along the substantially perpendicular bar portion 18. However, in alternative embodiments, the second adjustable member 14 may be attached at other locations along the substantially perpendicular bar portion 18. The first end portion 16 and the second end portion 18 are sufficiently long to prevent twisting, movement and removal of the first end portion 16 and the second end portion 18 from the coupler system.

In the preferred embodiment, as shown in FIG. 3, the locking mechanism includes a locking pin 21 and a lock 23. The locking pin 21 is placed through the aligned holes in the first adjustable member 12 and the second adjustable member 14 and the lock 23 is secured to the pin 21 to lock the shaft 11 in position. The transverse dimension of the locking mechanism prevents the assembled lock from being disengaged or sheared by a lateral twisting movement between the first adjustable member 12 and the second adjustable member 14. Preferably, the locking mechanism is formed of case hardened metal. The lock may be a key lock, a pin-tumbler lock, a warded lock, a wafer lock, a lever lock, a dial combination lock, a disc combination lock, or a push-button combination lock.

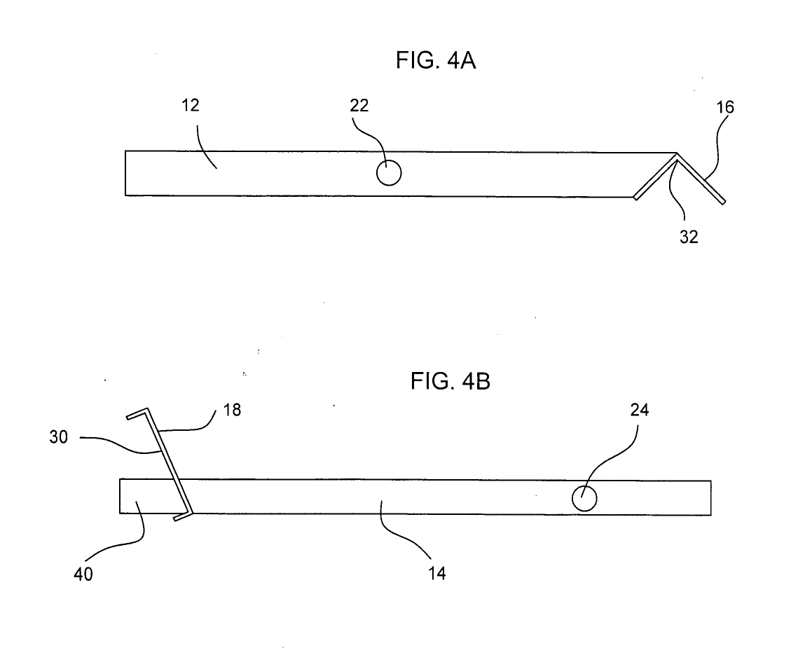

As shown in FIG. 4A, the wedge-shaped portion 32 may be formed by (i) an angle iron or (ii) two perpendicular members joined at about a 90° angle. Each of the perpendicular members of the wedge-shaped portion 32 is about 1 inch to about 2 inches in length. In the preferred embodiment, each of the perpendicular members is about 1.25 inches in length.

As shown in FIG. 4B, the channel 30 of the substantially perpendicular bar portion 18 is about 2 inches long. The channel portion 30 may be about 1.0 inch to about 3.0 inches wide. In the preferred embodiment, the channel portion 30 is about 2.0 inches in width, such that the C-shaped channel has dimensions of about 2 inches by about 0.5 inches. The channel portion 30 extends from the second adjustable member 14 at an angle of about 45° to about 70° (e.g., about 50° to about 65° or about 55° to about 60°). In the preferred embodiment, the substantially perpendicular bar portion 18 extends downwardly at an angle of about 57° from the second adjustable member 14, and is connected to the second adjustable member 14 at about 2.5 inches from the bottom of the exposed end 40 of the second adjustable member 14. In the preferred embodiment, the C-shaped channel portion is connected to the second adjustable member 14 at about 12.25 inches from the end 75 of the second adjustable member 14.

FIG. 4A and FIG. 4B also show the at least one hole 22 in the first adjustable member 12 and the at least one hole 24 in the second adjustable member 14. In use, once the adjustable shaft 11 is in place, a user aligns the holes and places the locking mechanism (shown in FIG. 1 and FIG. 3) therethrough to prevent further adjustments to the length of the shaft 11. Preferably, the at least one hole 22 in the first adjustable member 12 is about 5 inches to about 7 inches from the open end of the first adjustable member 12 (e.g., about 5.5 inches to about 6.5 inches). In the preferred embodiment, the at least one hole 22 in the first adjustable member 12 is about 6.25 inches from the open end of the first adjustable member. Preferably, the at least one hole 24 in the second adjustable member 14 is about 3 inches to about 6 inches from an end 75 of the second adjustable member 14 (e.g., about 3.5 inches to about 5.5 inches or about 4.0 inches to about 5.0 inches). In the preferred embodiment, the at least one hole 24 is located about 4.5 inches from the end 75 of the second adjustable member 14.

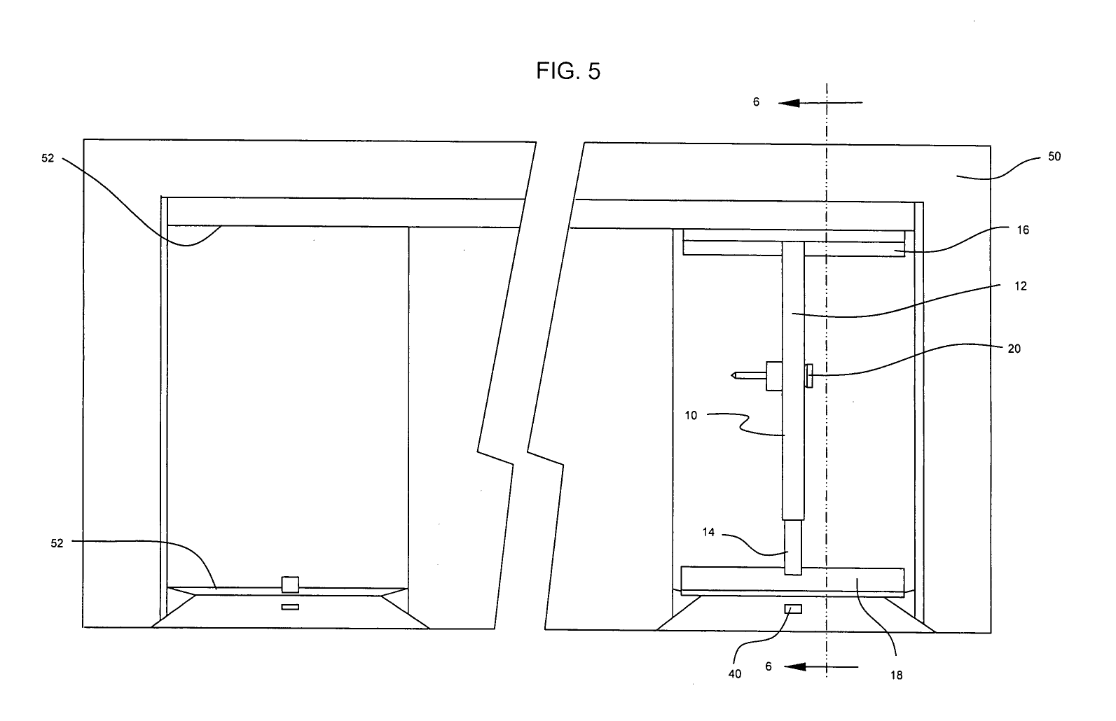

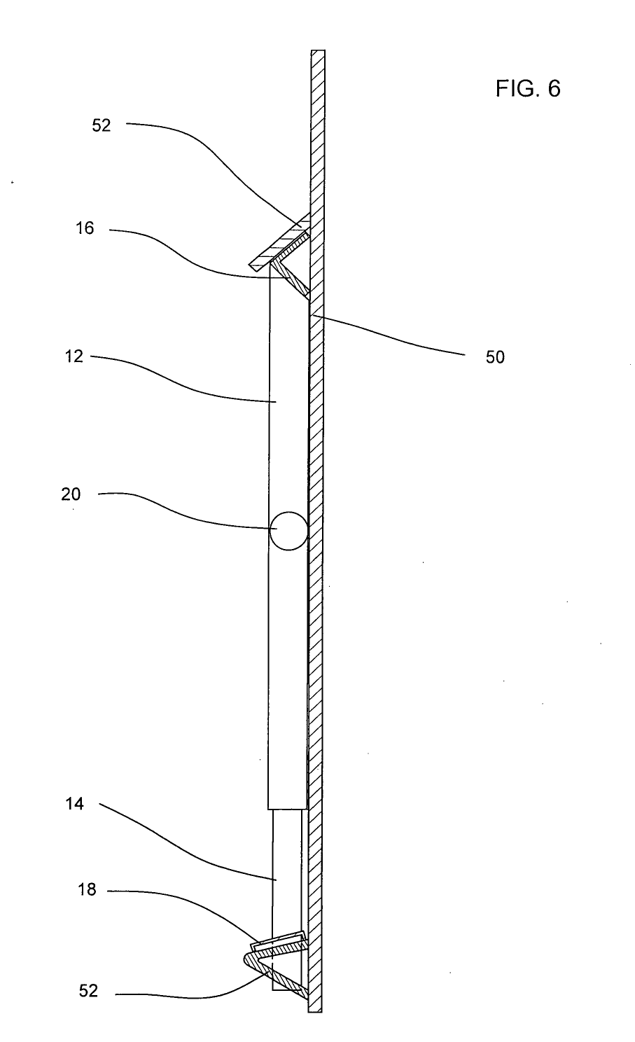

FIG. 5 and FIG. 6 show the anti-theft device 10 as installed on a machine-operated implement 50 for an earth mover via the universal coupler system 52. The wedge-shaped first end portion 16 of the first adjustable member 12 is received under an inclined plate at the tope of the universal coupler system 52. The exposed end 40 of the second adjustable member 14 is received in a hole at the bottom of the universal coupler system of the machine-operated implement, such that the substantially perpendicular bar portion 18 prevents the second adjustable member 14 from sliding through the hole in the coupler system of the attachment. The second adjustable member 14 is slid into or out of the first adjustable member 12 to snugly secure the anti-theft device 10 within the coupler system 52. When installed on a universal coupler system 52, the first adjustable member 12 lies flat against the machine-operated implement 50 as shown in FIG. 6. Also, when installed, the wedge-shaped first end portion 16 contacts the machine-operated implement 50. When installed, the length of the anti-theft device is about 16 inches to about 19 inches. In the preferred embodiment, the length of the anti-theft device, when installed, is about 18⅛ inches from the end of wedge-shaped first end portion 16 to the end of the exposed end 40 and about 16¾ inches from the end of the wedge-shaped first end portion 16 to the end of the substantially perpendicular bar portion 18.

Once the adjustable shaft 11 is at a sufficient length, the locking mechanism 20 is placed through the aligned holes in the first and second adjustable members 12, 14 to maintain the length of the adjustable shaft 11, such that the first end portion 16 engages the inclined plate at the top and the exposed portion 40 of the second adjustable member 14 is positioned within the hole at the bottom of the universal coupler system 52 of the machine-operated implement 50. Once locked in place, the anti-theft device 10 prevents the attachment of an earth mover to the machine-operated implement 50.

In this specification, the word “about” is often used in connection with numerical values to indicate that mathematical precision of such values is not intended. Accordingly, it is intended that where “about” is used with a numerical value, a tolerance of 10% is contemplated for that numerical value.

While the foregoing describes in detail an anti-theft device for machine-operated implements with reference to specific embodiments thereof, it will be apparent to one skilled in the art that various changes and modifications may be made to the anti-theft device and equivalents may be employed, which do not materially depart from the spirit and scope of the invention. Accordingly, all such changes, modifications, and equivalents that fall within the spirit and scope of the invention as defined by the appended claims are intended to be encompassed thereby.

We claim:

1. An anti-theft device for a machine-operated implement comprising:
an adjustable shaft; and
a locking mechanism,
wherein the anti-theft device is attachable to a machine-operated implement to interfere with attachment of an earth mover to said machine-operated implement.

2. The anti-theft device of claim 1, wherein the locking mechanism includes a locking pin and a lock.

3. The anti-theft device of claim 2, wherein the lock is a key lock or a key tumbler lock.

4. The anti-theft device of claim 1, wherein the anti-theft device is formed of a material selected from the group consisting of metal, wood, plastic, and combinations thereof.

5. The anti-theft device of claim 1, wherein the metal is case hardened metal.

6. The anti-theft device of claim 1, wherein the adjustable shaft includes a first adjustable member and a second adjustable member.

7. The anti-theft device of claim 6, wherein the first adjustable member and the second adjustable member includes at least one hole for receiving the locking mechanism.

8. The anti-theft device of claim 6, wherein the first adjustable member includes a first end portion.

9. The anti-theft device of claim 8, wherein the first end portion includes two substantially perpendicular members forming a wedge.

10. The anti-theft device of claim 8, wherein the first end portion is an angle iron.

11. The anti-theft device of claim 5, wherein the second adjustable member includes a substantially perpendicular bar portion.

12. The anti-theft device of claim 11, wherein the substantially perpendicular bar portion includes a C-shaped channel member.

13. The anti-theft device of claim 11, wherein the substantially perpendicular bar portion is located about 0.5 inches to about 5 inches from an exposed end of the second adjustable member.

14. The anti-theft device of claim 5, wherein the first adjustable member and the second adjustable member have a length of about 10 inches to about 20 inches.

15. The anti-theft device of claim 5, wherein the first adjustable member includes a hollow body adapted to at least partially receive the second adjustable member therein.

16. The anti-theft device of claim 15, wherein the hollow body has a round, square, rectangular, or polygonal cross-section.

17. The anti-theft device of claim 15, wherein the hollow body has an inner dimension of about 0.05 inches to about 2.0 inches.

18. A method of preventing the theft of an earth mover attachment comprising:
attaching an anti-theft device to an earth mover attachment,
wherein the anti-theft device prevents attachment of an earth mover to the earth mover attachment.

19. The method of claim 18, further including locking the anti-theft device in place.
